(19) United States
(12) Patent Application Publication
(10) Pub. No.: US 2010/0239628 A1
(43) Pub. Date: Sep. 23, 2010

(54) PRODUCT FOR WATER TREATMENT

(75) Inventor: Bruno Bartoletti Stella, Poggio Berni (RIMINI) (IT)

Correspondence Address: YOUNG & THOMPSON, 209 Madison Street, Suite 500, Alexandria, VA, 22314, US

(73) Assignee: GREENTRADING S.R.L., Santarcangelo di Romagna (RIMINI) (IT)

(21) Appl. No.: 12/682,948

(22) PCT Filed: Apr. 15, 2008
(86) PCT No.: PCT/IB2008/000909

§ 371 Date: Apr. 14, 2010

(30) Foreign Application Priority Data
Oct. 15, 2007 (IT) RN2007A000049

(51) Int. Cl. C02F 1/68; C02F 1/00

(52) U.S. Cl. 424/405; 210/766; 210/282; 210/269; 210/263; 210/198.1

(57) ABSTRACT

A product for water treatment includes a plurality of bioceramic materials, in which at least one bioceramic material is chosen from among the following: Alkali Energy Ceramic Ball, Antibacterial Pellet, Far Infrared Ceramic Ball, and may also include Mineral Ceramic Ball.

### TECHNICAL FIELD

This invention relates to a product for water treatment.

### BACKGROUND ART

Prior art includes several bioceramic materials for water treatment for various purposes, including human nutrition.

An important requirement is to obtain a bioceramic material-based product that presents particularly advantageous results, especially in livestock breeding, and to limit the quantity of detergent used for washing clothes and dishes or other items, that is to say to reduce the limescale that forms in the chambers which heat the water in the corresponding appliances.

### SUMMARY OF THE INVENTION

A product for water treatment is provided, comprising a plurality of bioceramic materials; characterised in that it comprises at least one of the following bioceramic materials: Alkali Energy Ceramic Ball, Antibacterial Pellet, Far Infrared Ceramic Ball.

By combining several bioceramic products it is therefore possible to maximize the advantageous effects, with respect to those that can be obtained with the single materials.

In particular, with the present product composition it is possible to purify the drinking water of a livestock farm, obtaining multiple advantages for the animals, as will be seen from the following description.

According to another advantageous aspect, a product is provided for water treatment, comprising a plurality of bioceramic materials, which is characterised in that it comprises at least one of the following bioceramic materials: Alkali Energy Ceramic Ball, Antibacterial Pellet, Far Infrared Ceramic Ball; and in that it comprises Mineral Ceramic Ball as a bioceramic material.

In particular, with the present product composition it is possible to purify the water used in a washing machine, reducing the use of detergent and the formation of limescale in the washing drum or in corresponding chambers for water heating in other appliances.

This invention can also be used in an advantageous filter and an advantageous cartridge for water treatment as described in the appended claims.

This invention can also be advantageously used for water treatment as described in the appended claims.

### BRIEF DESCRIPTION OF THE DRAWINGS

The advantageous technical characteristics of the invention, are clearly described in the detailed description which follows, with reference to the accompanying examples and drawings which illustrate preferred embodiments of the invention provided merely by way of example without restricting the scope of the inventive concept, and in which:

FIG. 1 is a side schematic view of a first preferred embodiment of a container used for water treatment using the product according to the invention;

FIG. 2 is a perspective view of a first preferred embodiment of a cartridge for water treatment, open and empty;

FIG. 3 is a perspective view of the first preferred embodiment of a cartridge for water treatment, closed and filled;

FIG. 4 is a perspective view of a second preferred embodiment of a cartridge for water treatment;

FIG. 5 is a perspective view of the second preferred embodiment of a cartridge for water treatment, inserted in a corresponding water conduction plant on a farm or elsewhere;

### DETAILED DESCRIPTION OF THE PREFERRED EMBODIMENTS OF THE INVENTION

According to one preferred embodiment, a product for water treatment is therefore provided, comprising a plurality of bioceramic materials in such a way as to maximize the advantageous effects with respect to those that can be obtained with the single materials.

In particular, it is advantageously foreseen that at least one of the bioceramic materials be chosen from the following materials: Alkali Energy Ceramic Ball, Antibacterial Pellet, Far Infrared Ceramic Ball.

In particular, the said Alkali Energy Ceramic Ball, Antibacterial Pellet, Far Infrared Ceramic Ball and the Mineral Ceramic Ball described below are materials identified as such and produced by the Chinese company Zibo Bona Science and Technology Development Co. Ltd.

In more detail, Alkali Enery Ceramic Ball comprises 60% Tourmaline, 10% Maifan Stone, 3% Multi-functional healthy ceramic material [Alkali and antibacterial] and other materials making up the remainder.

In turn, Antibacterial Pellet comprises 30% Tourmaline, 1-3% Antibacterial powder and 5-7% Multi-functional healthy ceramic material.

Far Infrared Ceramic Ball comprises 30% Tourmaline, 3-5% Far Infrared powder and 5-7% Multi-functional healthy ceramic material.

In particular, Alkali Energy Ceramic Ball advantageously accounts for between 60% and 80% of the product weight, preferably between 65% and 75% of the product weight.

In addition, Antibacterial Pellet advantageously accounts for between 14% and 18% of the product weight, preferably between 15% and 17% of the product weight, and Far Infrared Ceramic Ball for between 14% and 18% of the product weight, preferably between 15% and 17% of the product weight.

This composition of bioceramic materials is particularly suitable for livestock breeding, and in particular it makes it possible to “activate” the animals' drinking water, to improve their metabolism.

It is possible to use cartridges containing the product and inserted in the drinking troughs, or filters containing these cartridges inserted directly into the system for water conduction to the farms, or in the case of small animals the product can be placed directly in the drinking bowls.

The product remains in contact with the water for many months, improving the properties of the water, for example the taste, and leaving all the usual properties of drinking water unchanged.

In particular, an improvement in the health and physical appearance of the animals is obtained.

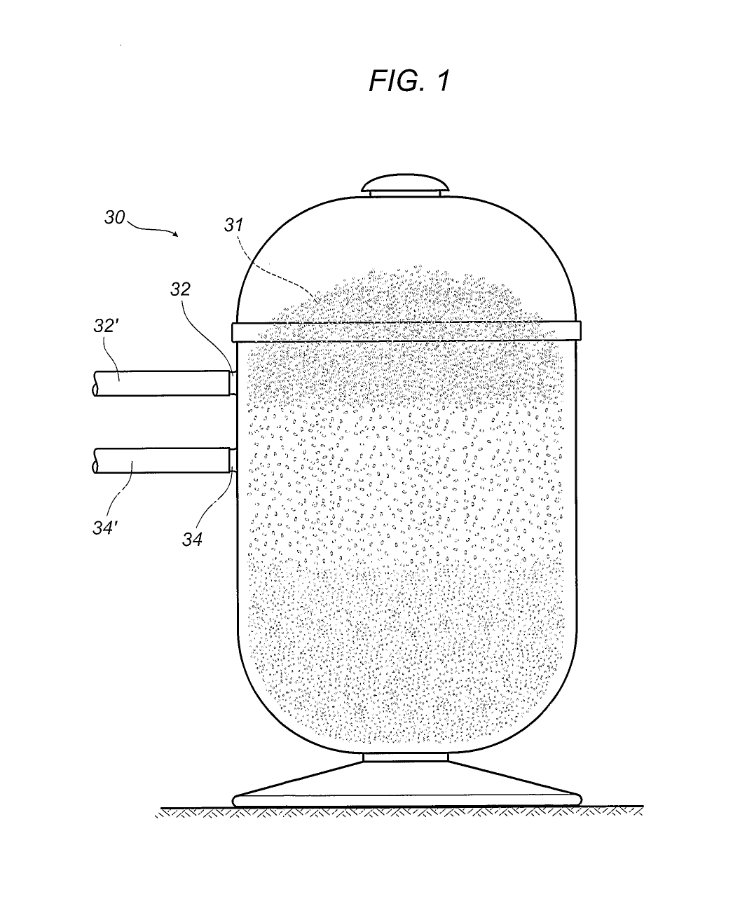

The product can be advantageously placed in a corresponding container filter 30, which is inserted in the farm's water conduction system, schematically shown in FIG. 1.

In particular, the container filter is in the form of a body 30, preferably made from fibreglass-reinforced plastic, which presents an inner chamber to hold the product 31 and an inlet 32, connected to a water intake conduit 32′, and an outlet 34, connected to a water outlet conduit 34′ for the farm drinking water system.

The container filter 30 presents appropriate means, not shown in detail, for the passage of the water towards the outlet 34, these means extend in a distributed way in the product housing chamber and do not allow the material in the product to enter. In addition, the entrance to the chamber is equipped with means which extend inside the container chamber 30 and allow a uniform distribution of the water inside the chamber.

This container can hold around 100 kg of product; if it is necessary to use several container filters, for a particularly demanding use, several container filters of the type described above can be connected in parallel to each other, varying in number according to the specific requirements.

It is also possible to use the container named Europa produced by the Italian company Canale Antonio & C. based in Schio.

### Example 1

A first and a second container according to the first embodiment are filled with a respective quantity of 1000 g of product for each animal, consisting of 70% Alkali Energy Ceramic Ball, 15% Antibacterial Pellet and 15% Far Infrared Ceramic Ball, and are inserted in the water conduction system of a farm, which has 150 cows used to produce milk suitable for making into Parmesan cheese. The test was carried out for a period of approximately thirty days.

Careful observation of the entire herd in these thirty days of treatment showed a significant improvement in the health of the cows which visited the feeding troughs more frequently; they also appeared more alert and produced very homogeneous, semi-solid, well-digested faeces, of a green-brownish colour typical of animals with a healthy digestive system.

The characteristics of the milk produced in this period also showed a positive alteration both in terms of quality (significant increase in fat and protein) and quantity (an increase of 1.5 kg of milk/cow per day).

In fact, the treatment of the drinking water with the product represents a valid aid in improving the health of dairy cows and can, consequently, give the farmer undisputable management and economic benefits.

### Example 2

A container according to the first embodiment is filled with a respective quantity of 750 g of product for each horse, consisting of 70% Alkali Energy Ceramic Ball, 15% Antibacterial Pellet and 15% Far Infrared Ceramic Ball, and is inserted in the water conduction system of a farm, which has 25 horses. Six dogs, present on the farm, were also given the treated water to drink. The test was carried out for more than six months.

In the horses, a general reduction in colic and problems caused by gastrointestinal ulcers was observed. The horses were also calmer and took less time to recover from fatigue. Besides, the faeces produced by the animals were always compact, which is a sign of good digestion. Their urine also changed colour and odour and they urinated more frequently. The general physiological checks carried out on the 25 horses in the stable showed excellent values. Moreover, all the horses also improved their racing performance.

The findings in the dogs, even the elderly ones, showed that their fur had become glossier and more attractive (a sign of good health) and that they were livelier than before the use of the bioceramic materials. The analyses performed before and after the use of bioceramic materials showed a general improvement of the parameters.

In accordance with a second preferred embodiment of product for water treatment, which comprises a plurality of bioceramic materials, in such a way as to maximize the advantageous effects with respect to those that can be obtained with the single materials, it is advantageously foreseen that at least one of the bioceramic materials be chosen from the following materials: Alkali Energy Ceramic Ball, Antibacterial Pellet, Far Infrared Ceramic Ball and that Mineral

Ceramic Ball is used.

Mineral Ceramic Ball comprises 5% Tourmaline, 40% Maifan Stone, 15% Calcium Carbonate (CaCO3), 5-7% Multi-functional healthy ceramic material and other clays making up the remainder.

In particular, Mineral Energy Ceramic Ball advantageously accounts for between 40% and 70% of the product weight, preferably between 45% and 55% of the product weight.

In addition, Alkali Energy Ceramic Ball advantageously accounts for between 14% and 18% of the product weight, preferably between 15% and 17% of the product weight.

Furthermore, Antibacterial Pellet advantageously accounts for between 14% and 18% of the product weight, preferably between 15% and 17% of the product weight, and Far Infrared Ceramic Ball for between 14% and 18% of the product weight, preferably between 15% and 17% of the product weight.

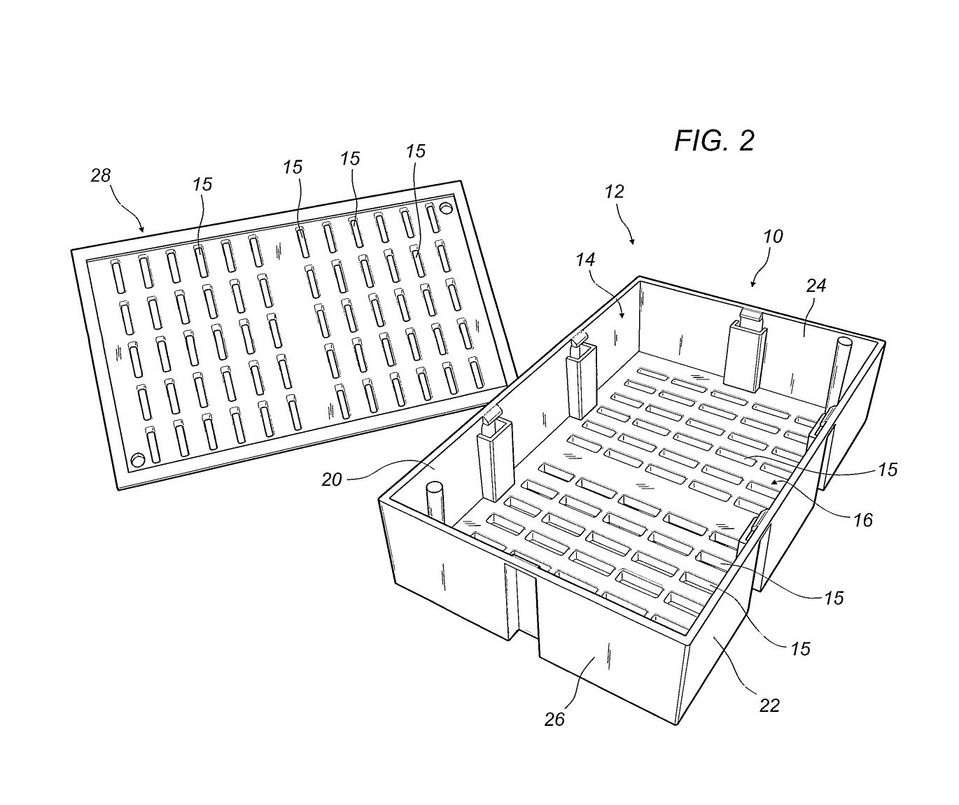

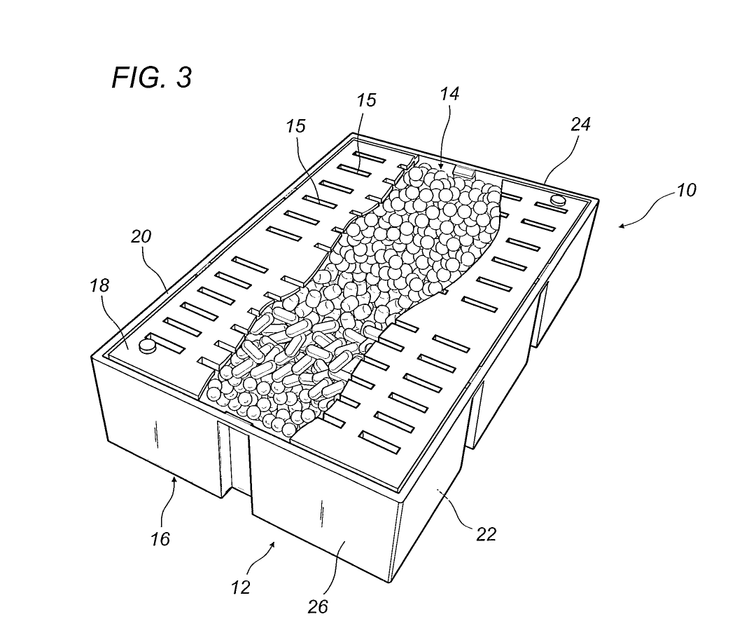

The product can be advantageously placed inside a cartridge, shown in FIGS. 2 and 3, which is housed in the chamber of a washing machine, for industrial or domestic use, and which uses liquid or powder detergent.

Whether positioned outside or inside washing machines, before or after the intake of water into the washing machine, the product makes it possible to reduce detergent consumption by 50% to 90%, achieving good washing results, decreasing the residues of detergent on the washed items and reducing environmental pollution.

In addition, applying this product to the water intake, either on washing machines or other types of machines or equipment that use heated water, prevents the accumulation of limescale in the respective heated chambers, thus avoiding the use of costly additional softeners.

This second embodiment 10 of a cartridge for water treatment comprises a container body 12, defining a chamber 14 for housing a product for water treatment, and presents advantageous opening means 15 to allow water to pass into and out of the housing chamber 14.

As can be clearly seen in FIG. 2, the container body presents advantageous means of access to the housing chamber 14 for the removal and insertion of the material in the housing chamber 14, once it has lost its efficacy and the cartridge needs to be refilled with product.

As shown, the container body 12 presents a bottom wall 16, side walls 20, 22, 24, 26, and an upper wall 18, this upper wall being advantageously removable to form the means of access to the housing chamber 14.

As can be seen, this embodiment of a cartridge 10 is in the shape of a -flattened parallelepiped, with wide upper and lower walls 16, 18 and long narrow side walls 20, 22 plus short narrow head and tail walls 24, 26.

Advantageously, the opening means are positioned in correspondence with one of the walls of the container body, in particular in correspondence with the upper wall 18 and the bottom wall 16, defining a respective opening cover, and are in the form of a plurality of holes 15, distributed along these walls.

Advantageously, as shown, the dimensions of the product material are greater than the minimum dimensions of the holes 15.

### Example 3

A container according to the second embodiment is filled with a respective quantity of product (120 g) consisting of 50% Mineral Ceramic Ball and, for the remainder, equal quantities of Alkali Energy Ceramic Ball, Antibacterial Pellet and Far Infrared Ceramic Ball, and inserted in the washing chamber of a washing machine for approximately one year.

The results obtained show the efficacy of the product in a washing machine, in which items were washed with doses of less than 70% of the detergent normally used and all the limescale that had accumulated inside the machine was removed.

This product can be used in domestic and industrial washing machines, in domestic and industrial dishwashers, in steam ovens, with washing or shower systems, and in coffee machines.

As may seem obvious, the container in which the product is housed can be made in other shapes and from other materials, on the condition that it is equipped with openings for the water to pass through.

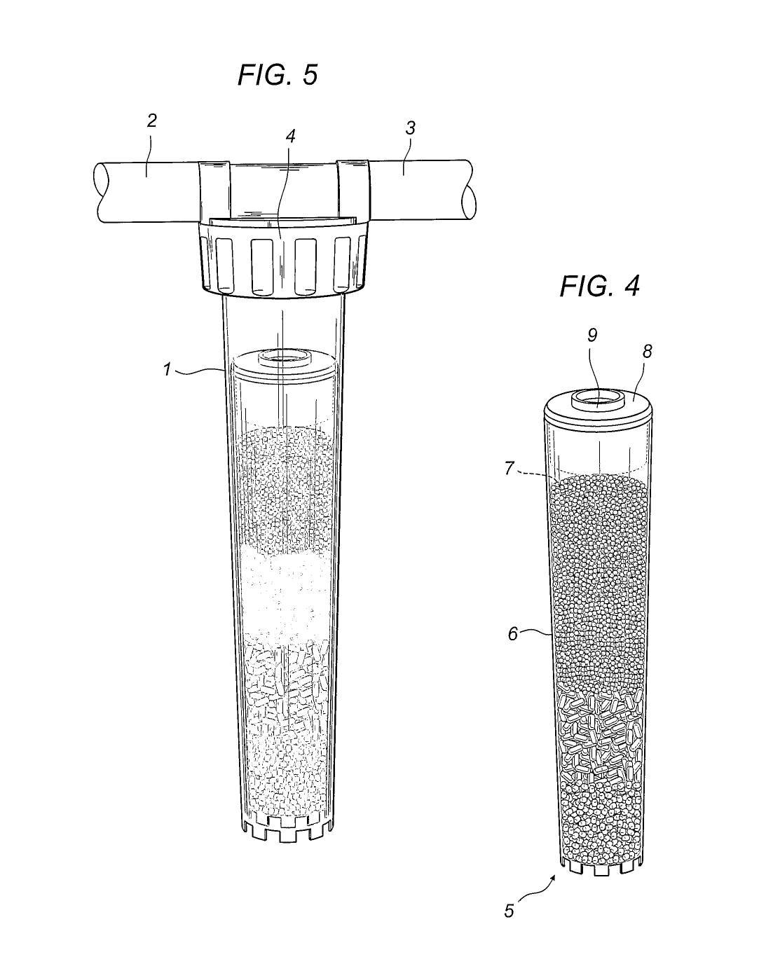

It is also possible to advantageously use the cartridge shown in FIGS. 4 and 5, which is inserted in the water conduction system of a farm or of a washing system or the like, in particular in a filter 1, in the form of a body which houses the cartridge and which is connected between an intake conduit 2 and a delivery conduit 3, by means of a connector 4, which causes the water to pass inside the body 1, being fitted with a ring nut for a removable connection to allow refilling of the filter.

The cartridge 5 comprises an opening 9 for entry into and exit out of the chamber housing the filter 1 and presents a body 6 with a slightly conical shape, flaring towards the top, defining an inner chamber 7 for housing the product and a plug 8, for access to the chamber 7, with a hole or opening 9.

It is possible to use a filter containing from 50 to 2000 grams of product, preferably from 120 to 2000 grams, to be positioned outside or inside the machines before or after the water intake. The quantity of product used is naturally proportional to the amount of water; for example, for a coffee machine for domestic use a cartridge containing 50 g of product would be used, while for a washing machine with a capacity of 15 kg a cartridge containing 200 g of product could be used.

In addition, the ceramic product can be used in different ways as long as it comes into contact with the water. For example, the bioceramic product can be housed inside a filter made from plastic, metal, steel or ceramics, positioned at the water intake of each individual room, such as the water intake in a professional kitchen or in a room used as a laundry; in this case, the filter will condition the water reaching all the washing machines installed in this room.

The composition of this invention makes it possible to wash fabrics and dishes with a considerable reduction of environmental pollution and, above all, guaranteeing a marked economic saving as well as preventing the formation of limescale, with a consequent saving in maintenance operations and a longer life of the machines and equipment.

The infrared rays emitted by this bioceramic product are not harmful for humans.

In practice, the use of this product is foreseen for treatment of the water used by a machine in which the water is heated, in particular a washing machine, and in which from 50 to 2000 grams of product are used, preferably from 120 to 2000 g.

Use of this product for the drinking water of any animal, including pets, can be easily imagined.

The invention described above is susceptible to industrial application and may be modified and adapted in several ways without thereby departing from the scope of the inventive concept. Moreover, all the details of the invention may be substituted by technically equivalent elements.

1. A product for the treatment of water, comprising a plurality of bioceramic materials; characterised in that it comprises at least one of the following bioceramic materials: Alkali Energy Ceramic Ball, Antibacterial Pellet, Far Infrared Ceramic Ball.

2. A product according to claim 1, characterised in that it comprises Mineral Ceramic Ball as a bioceramic material.

3. A product according to claim 1, characterised in that Alkali Energy Ceramic Ball accounts for between 14% and 18% of the product weight, preferably between 15% and 17% of the product weight.

4. A product according to claim 1, characterised in that Alkali Energy Ceramic Ball accounts for between 60% and 80% of the product weight, preferably between 65% and 75% of the product weight.

5. A product according to claim 1, characterised in that Antibacterial Pellet accounts for between 14% and 18% of the product weight, preferably between 15% and 17% of the product weight.

6. A product according to claim 1, characterised in that Far Infrared Ceramic Ball accounts for between 14% and 18% of the product weight, preferably between 15% and 17% of the product weight.

7. A product according to claim 1 from 3 to 6, characterised in that Mineral Ceramic Ball accounts for between 40% and 70% of the product weight, preferably between 45% and 55% of the product weight.

8. Method of treating water used by a machine in which the water is heated, which comprises contacting the water with the product according to claim 1.

9. The method according to claim 8, in which the water used by a washing machine is treated.

10. The method according to claim 8, characterised in that from 50 to 2000 grams of product are used, preferably from 120 to 2000 grams.

11. Method of treating drinking water on a livestock farm, which comprises contacting the drinking water with the product according to claim 1.

12. The method according to claim 11, characterised in that from 750 to 1000 grams of product per treated animal are used.

13. A cartridge (10) for the treatment of water, characterised in that it comprises a container body (12) defining a chamber (14) for housing a product for the treatment of water, characterised in that it comprises a product for the treatment of water according to claim 1.

14. A cartridge according to claim 13, characterised in that it comprises a container body (12) presenting opening means (15) to allow the water to pass into and out of the housing chamber (14).

15. A cartridge according to claim 13, characterised in that it presents access means to the housing chamber (14) for the removal and insertion of the material in the housing chamber (14).

16. A cartridge according to claim 13, characterised in that it comprises a container body (12) presenting a bottom wall (16), side walls (20, 22, 24, 26) and an upper wall (18).

17. A cartridge according to claim 13, characterised in that it comprises a wall that can be removed to define the means of access to the housing chamber (14).

18. A cartridge according to claim 13, characterised in that it presents a parallelepiped conformation.

19. A cartridge according to claim 13, characterised in that it comprises opening means (15) in a respective wall of the container body.

20. A cartridge according to claim 19, characterised in that the opening means (15) are in the form of a plurality of holes, in particular distributed in a substantially uniform way on the corresponding wall.

21. A cartridge according to claim 19, characterised in that the opening means are in the upper wall of the container body.

22. A cartridge according to claim 19, characterised in that the opening means are in the bottom wall of the container body.

23. A cartridge according to claim 13, characterised in that the smallest dimension of the product material is greater than the minimum dimension of the holes.

24. A cartridge according to claim 13, characterised in that it comprises an opening for the entry and exit of the water.

25. A cartridge according to claim 24, characterised in that it has a slightly conical shape.

26. A filter for the treatment of water, characterised in that it comprises a container body (30, 1) defining a chamber for housing a product for water treatment, and can be inserted in a water supply conduit, characterised in that it comprises a product for water treatment according to claim 1.

27. A filter for the treatment of water, characterised in that it contains a cartridge according to claim 13.
